(19) United States
(12) Patent Application Publication
(10) Pub. No.: US 2009/0200227 A1
(43) Pub. Date: Aug. 13, 2009

(54) PLEATED FLUID TREATMENT ARRANGEMENTS AND METHODS FOR STABILIZING THE PLEATS

(75) Inventors: Atsushi Sakamoto, Ibaraki (JP); Hisayuki Kataoka, Chiba (JP); Hajime Hiranaga, Ibaraki (JP)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, East Hills, NY (US)

(21) Appl. No.: 11/914,557

(22) PCT Filed: May 16, 2006
(86) PCT No.: PCT/US06/18888

§ 371 Date: Aug. 6, 2008

Related U.S. Application Data
(60) Provisional application No. 60/681,010, filed on May 16, 2005.

(51) Int. Cl. B01D 29/21; B01D 39/14

(52) U.S. Cl. 210/493.1; 210/485

(57) ABSTRACT

Pleated fluid treatment arrangements may comprise a stabilizing arrangement coupled between a support and some or all of the pleats. The stabilizing arrangement may include a plurality of projections, each projection extending through an opening in the support and into an open end of a pleat. Methods for stabilizing pleat legs may comprise inserting a projection of a stabilizing arrangement through an opening in a support and into an open end of a pleat.

### DISCLOSURE OF THE INVENTION

The present invention relates to pleated fluid treatment arrangements and to methods for stabilizing the pleats of fluid treatment arrangements.

Pleated fluid treatment arrangements embodying one or more aspects of the invention may be used to treat fluids, including gases, liquids, or mixtures of gases, liquids, and/or solids, in a wide variety of ways. For many embodiments, the arrangement may be used in a separation process to separate one or more substances from the fluid. For example, all, or a portion, of the fluid may be directed through the fluid treatment arrangement, and the separation process may be a filtration process, where substances in the fluid, including, for example, particles above a certain size, are prevented from passing through the fluid treatment arrangement as fluid flows through it. Alternatively, or additionally, the separation process may be a capture process, where substances in the fluid, including, for example, ions, molecules, or proteins, are chemically or physically bound to the fluid treatment arrangement as fluid flows through it.

Pleated fluid treatment arrangements embodying one or more aspects of the invention may be configured in a wide variety of ways. For example, a fluid treatment arrangement may comprise a hollow, generally cylindrical fluid treatment pack having an inner side and an outer side and a plurality of pleats. For many embodiments, the pleats may have ridges which extend along the inner side and the outer side of the fluid treatment pack axially from one end to the opposite end. For other embodiments, the ridges of the pleats may extend in other directions, including, for example, circumferentially or helically. The pleated fluid treatment arrangement may further comprise at least one generally cylindrical support which is positioned adjacent to the outer side or the inner side of the fluid treatment pack. For many embodiments, the cylindrical support may be an external support or surround, including, for example, an external sleeve, wrap, or cage, which surrounds and faces the pleats along the outer side of the fluid treatment pack. Alternatively, or additionally, the cylindrical support may be an internal support, including, for example, an internal core, which surrounds and faces the pleats along the inner side of the hollow fluid treatment pack. The cylindrical support may have openings, including, for example, perforations or other regular or irregular openings, allowing fluid to flow outside-in or inside-out through the fluid treatment arrangement. The cylindrical support may serve to support the fluid treatment pack against forces directed inwardly or outwardly when fluid flows through the pack and/or to protect the fluid treatment pack from damage.

As another example, a fluid treatment arrangement may comprise a pleated fluid treatment pack having the shape of a flat box. Some of the ridges of the pleats may extend along the top side of the fluid treatment pack and some of the pleat ridges may extend along the bottom side of the fluid treatment pack. The fluid treatment arrangement may further comprise a flat support which is positioned adjacent to the top side of the fluid treatment pack facing the pleats and/or a flat support which is positioned adjacent to the bottom side of the fluid treatment pack facing the pleats. The flat support may have regular or irregular openings which allow fluid to flow top-to-bottom or bottom-to-top through fluid treatment arrangement.

In accordance with one aspect of the invention, fluid treatment arrangements may comprise a fluid treatment pack, a support, and a stabilizing arrangement. The fluid treatment pack may have first and second opposite sides and a plurality of pleats. Each pleat may include an open end, a folded end, and a pair of legs extending between the folded end and the open end. The support may be positioned adjacent to the fluid treatment pack facing one side and may have a plurality of openings. The stabilizing arrangement may be coupled between the support and some or all of the pleats. The stabilizing arrangement may include a plurality of projections, and each projection may extend through an opening in the support and into the open end of a pleat.

Fluid treatment arrangements which embody one or more aspects of the invention have many advantages. For example, because the stabilizing arrangement is coupled between the support and the pleats, the projections of the stabilizing arrangement securely maintain the pleat legs spaced from one another at the open ends of the pleats. By spacing the pleat legs apart, the stabilizing arrangement prevents the pleat legs from collapsing against one another and closing off the open end of the pleat when fluid flows into the open ends of the pleats. This can increase the amount of particulate matter or other substances that the fluid treatment arrangement collects because a larger area of the fluid treatment pack remains available to collect these substances. Further, the stabilizing arrangement can securely maintain the pleat legs more uniformly spaced from one another. Consequently, the substances to be collected by the fluid treatment pack 11 may be distributed more evenly along the larger area of the fluid treatment pack, which can substantially increase the service life of the fluid treatment arrangement.

In accordance with another aspect of the invention, methods for stabilizing the legs of the pleats of a fluid treatment pack may comprise coupling a stabilizing arrangement between some or all of the pleats of the fluid treatment pack and a support facing the pleats. Coupling the stabilizing arrangement between the pleats and the support may include inserting a projection of the stabilizing arrangement through an opening in the support and into an open end of the pleat.

Methods for stabilizing the pleats legs which embody one or more aspects of the invention also have many advantages. The pleat legs may be quickly and securely stabilized by simply inserting the projections of the stabilizing arrangement through openings in the support and into the open ends of the pleats. Further, the pleats may be stabilized at any convenient time. For example, the fluid treatment pack may be formed and mounted to the support at a manufacturing site. However, the stabilizing arrangement may be mounted to the support and the fluid treatment pack at the manufacturing site, at the customer's site, or anywhere in between, e.g., at a warehouse, thus allowing greater flexibility in the process for making the fluid treatment arrangement.

### BRIEF DESCRIPTION OF THE DRAWINGS

FIG. 1 is a side view of a fluid treatment arrangement.

FIG. 2 is a partially sectioned view of the fluid treatment arrangement of FIG. 1.

FIG. 3 is a side view of a stabilizer.

FIG. 4 is a side view of another stabilizer.

FIG. 5 is a side view of another stabilizer.

FIG. 6 is a representational view of a test system.

FIG. 7 is a graph.

FIG. 8 is a partially sectioned view of another fluid treatment arrangement.

FIG. 9 is an oblique view of another fluid treatment arrangement.

### DESCRIPTION OF EMBODIMENTS

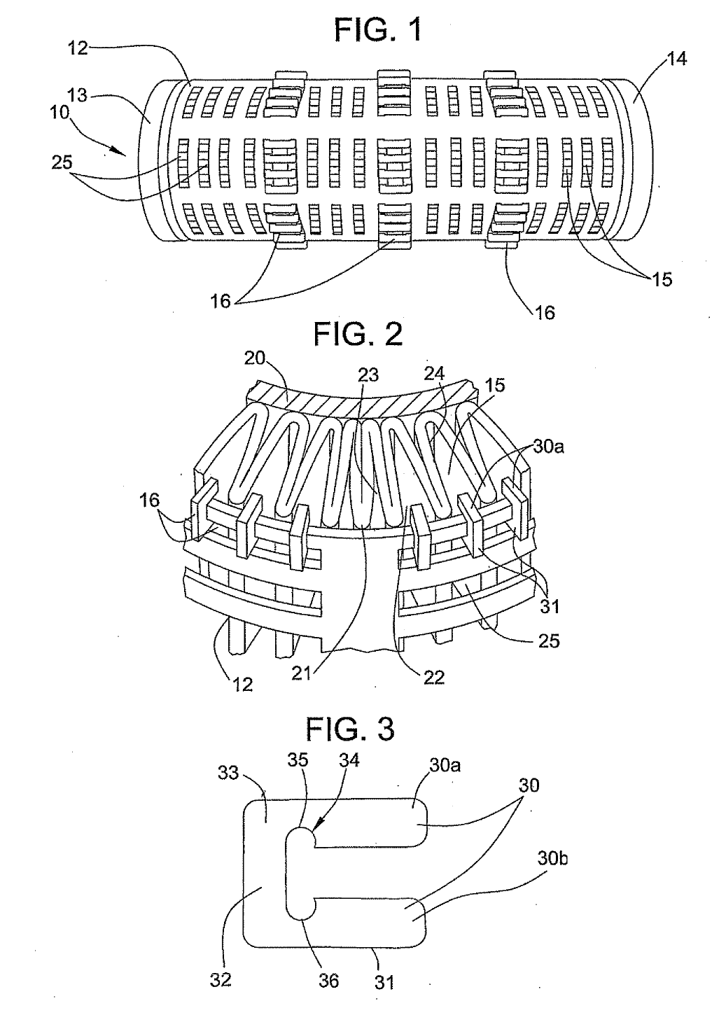

Fluid treatment arrangements embodying one or more aspects of the invention may be configured in any of numerous ways. One example of a fluid treatment arrangement 10 is shown in FIGS. 1 and 2. The illustrated fluid treatment arrangement 10 may comprise a fluid treatment element which includes a hollow fluid treatment pack 11 and an external support or surround 12 sealed to first and second end caps 13, 14 at opposite ends of the hollow fluid treatment pack 11. The fluid treatment pack may have a generally cylindrical configuration with a longitudinal axis and may include a plurality of pleats 15. A stabilizing arrangement 16 may be coupled between some or all of the pleats 15 and the external support 12. The fluid treatment arrangement 10 may comprise other components. For example, an internal support 20, such as a perforated core, may be positioned adjacent to the pleats 15 along the inner side of the fluid treatment pack 11.

The end caps 13, 14 may be formed from a variety of impermeable materials, including metals or polymers, and may be sealed to the ends of the fluid treatment pack 11 in a variety of ways. For example, the ends of the fluid treatment pack 11 and the end caps 13, 14 may be bonded, e.g., solvent bonded, melt bonded, or bonded with a potting compound such as an adhesive or a sealant. As another example, the ends of the fluid treatment pack 11 and the end caps 13, 14 may be welded, e.g., friction welded, sonic welded, or heat welded. One of the end caps 13, 14 may be an open end cap having an opening which communicates with the interior of the hollow fluid treatment pack 11, while the other end cap may be a blind end cap which seals off that end of the fluid treatment arrangement 10. Alternatively, both end caps may be open end caps.

The fluid treatment pack 11 may be fashioned from a single layer of a permeable fluid treatment medium or from a multilayer composite which includes one or more layers of a permeable fluid treatment medium. A variety of fluid treatment media may be used. For example, the fluid treatment medium may comprise any of a wide variety of filtration media, including microfiltration, ultrafiltration, or nanofiltration media. Alternatively, the fluid treatment medium may comprise any of a wide variety of capture media, including media having functional chemical groupings that capture and bind one or more substances to the media. The surface of the fluid treatment medium may naturally have, or may be modified to have, any desirable characteristic. For example, the surface of the fluid treatment medium may have a positive, a negative, or a neutral electrical charge or may be hydrophilic or hydrophobic. Further, the fluid treatment medium may have any desirable structure and may be formed from any desirable material. For example, the fluid treatment medium may be a permeable membrane, fibrous layer, or woven or nonwoven sheet or mesh and may be formed from a metal, a polymer, or fiberglass.

If the fluid treatment pack 11 comprises a multilayer composite, any number of other layers may be included in addition to the fluid treatment medium. For example, the multilayer composite may comprise a drainage layer, e.g., a drainage mesh, along one or both sides, e.g., the upstream side and/or the downstream side, of the fluid treatment medium. As another example, a cushioning layer may be included between the fluid treatment medium and a drainage layer.

The internal and external ridges of the pleats 15 of the fluid treatment pack 11 may run generally axially from one end of the pack 11 to the other, as shown in FIG. 1. Alternatively, the pleats may run in other directions, e.g., circumferentially around the axis or helically along the axis. The pleats may be formed in a variety of ways. For example, a single layer or a multilayer composite may be folded back and forth on itself in a zigzag fashion by a corrugator. Alternatively, the pleats may be formed by depositing fibers or wrapping sheets around a shaped structure such as a shaped mandrel. Various fluid treatment packs, including pleats running in various directions and pleats formed by various techniques, are disclosed, for example, in U.S. Pat. No. 5,543,047 and U.S. Provisional Application No. 60/658,163, which are incorporated by reference.

As shown in FIG. 2, each pleat 15 has a folded end 21 which may define the pleat ridge, an open end 22, and two legs 23, 24 which extend between the folded end 21 and the open end 22. The folded ends 21 may lie along one side of the fluid treatment pack 11 while the open ends 22 lie along the opposite side, or vice versa. For example, the folded ends 21 of the pleats 15 may lie along the inner side of the cylindrical fluid treatment pack 11 and the open ends 22 may lie along the outer side. Alternatively, the folded ends 22 may lie along the outer side and the open ends 21 may lie along the inner side of the cylindrical fluid treatment pack 11. Further, the pleats 15 may extend radially between the inner and outer sides of the fluid treatment pack 11, as shown in FIG. 2. Alternatively, the pleats may extend in a curved, arcuate, angled, or straight nonradial direction as disclosed in U.S. Pat. No. 5,543,047.

The internal support 20 may have a plurality of channels or a plurality of openings, e.g. perforations, which allow fluid to flow outside-in or inside-out through the fluid treatment arrangement 10. The internal support may be formed from a material such as a metal or polymer which has sufficient structural integrity to support the pleated fluid treatment pack 11 against forces directed radially inwardly when the fluid pressure on the exterior of the fluid treatment pack 11 is greater than the fluid pressure in the interior.

The external support 12 may serve several functions. For example, it may support the pleated fluid treatment pack against forces directed radially outwardly when the fluid pressure in the interior of the fluid treatment pack is greater than the fluid pressure on the exterior. The external support may also serve to hold the pleats in position, including, for example, to maintain the pleats in a curved, arcuate, angled, or straight nonradial configuration. The external support may further serve to protect the fluid treatment pack from damage, for example, when the fluid treatment arrangement is being handled during shipping or installation.

The external support may be structured in a variety of ways and from a variety of materials. For example, the external support may comprise a wrap member tightly wrapped around the fluid treatment pack as one or more circumferential or helical windings. The wrap member may be fashioned from a flexible material, including, for example, a woven or non woven fibrous sheet or a mesh formed from a polymeric or metallic material. The wrap member may, for example, be fixed to itself, to the end caps, and/or to the fluid treatment pack to maintain the wrap member taut around the fluid treatment pack. Alternatively, the external support may comprise a cylindrical sleeve closely positioned around the fluid treatment pack. The sleeve may be fashioned from a somewhat flexible material, including, for example, a thicker polymeric mesh. For many embodiments, the external support 12 may comprise a somewhat rigid cylindrical cage positioned closely around the fluid treatment pack 11 and fashioned from a polymeric or metallic material.

The external support 12 further includes regular or irregular openings 25 which allow fluid to flow into or out of the fluid treatment pack 11. The openings may be configured in any of numerous ways. For example, the openings may comprise mesh openings, such as generally square, rectangular or diamond-shaped openings, between the strands of a mesh. As another example, the openings may be gaps between the circumferential or helical windings of a wrap member. As another example, the openings may comprise circular or quadrilateral perforations or other openings, distributed regularly or irregularly around a sleeve or cage. For many embodiments, a sufficient number of openings 25 are distributed around the external support 12 to provide access to at least about 50% of the pleats 15, including, for example, at least 80% or at least 90% or 100% of the pleats 15.

The stabilizing arrangement 16 serves to couple some or all of the pleats 15 to the support, e.g., the external support 12, and, thereby, stabilize the pleats, which provides many advantages. For example, with the stabilizing arrangement 16 securely coupled between the stable support 12 and the pleats 15, the stabilizing arrangement 16 can securely maintain the pleat legs 23, 24 spaced from one another at the open ends 22 of the pleats 15. By spacing the pleat legs 23, 24, the stabilizing arrangement 16 substantially prevents the pleat legs 23, 24 from collapsing against and contacting one another and closing off the lower portion of the pleat 15. Consequently, the stabilizing arrangement 16 may increase the dirt capacity or the capture capacity of the fluid treatment arrangement 10 because a larger area of the fluid treatment pack 11 is available to collect dirt or other substances. Alternatively or additionally, the stabilizing arrangement 16 can more securely fix the pleats 15 in position by mechanically connecting the pleats 15 to the support, e.g., the external support 12. By securely positioning the pleat legs 23, 24 uniformly spaced from one another, the substances to be collected and/or captured by the fluid treatment pack 11 may be distributed more evenly along the larger area of the fluid treatment pack 11, which can substantially increase the service life of the fluid treatment arrangement 10.

The stabilizing arrangement 16 includes a plurality of projections 30, each of which may extend through an opening 25 in the external support 12 and into an outer open end 22 of a pleat 15. For many embodiments, the stabilizing arrangement may extend through the openings in the support without completely blocking off the openings. The stabilizing arrangement may be configured in any of numerous ways. For example, the stabilizing arrangement may be one integral piece, including, for example, a long band which has a plurality of projections extending from one side. The band may be wrapped circumferentially or helically around the external support with the projections extending through the openings in the support and into the open ends of the pleats.

For many embodiments, the stabilizing arrangement 16 may comprise a plurality of individual stabilizers 31, each stabilizer having one or more projections 30. The individual stabilizers of the stabilizing arrangement may be similar or dissimilar, and each stabilizer may be configured in any of a variety of ways. For example, a stabilizer 31 may have only two projections 30a, 30b, as shown in FIG. 3, and the projections may be similar or dissimilar. Each projection may have any of a variety of shapes. For example, as shown in FIG. 3, the projections 30a, 30b may be generally straight, which may facilitate insertion of the projection 30a, 30b into the open end 22 of a pleat 15 that extends in a straight, generally radial direction between the interior and the exterior of the fluid treatment pack 11. Alternatively, the projection may not be straight. For example, it may extend in a curved or angled direction. This may facilitate insertion of the projection into the open end of a pleat that extends in a curved, arcuate, angled, or straight nonradial direction between the interior and the exterior of the fluid treatment pack. Whether the projection is straight or not straight, the projection 30 may be long enough to extend a distance into the open end 22 of the pleat 15 that is sufficient to stabilize to the legs 23, 24 of the pleat 15. For example, the projection 30 may extend into the open end 22 of the pleat 15 a distance that is in the range from about 10% or less to 100% of the length from the open end 22 to the folded end 21 between the legs 23, 24 of the pleat 15. For many embodiments, the distance may be from about 20% to about 40% of the length from the open end 22 to the folded end 23 between the legs 23, 24 of the pleat 15.

Each projection may have any of a variety of cross-sections. For example, the cross-section of the projection may be circular or oval or rectangular. The cross-section of each projection shown in FIG. 3 may be square. For many embodiments, the opposing portions of the projection that contact the pleat legs 23, 24 may have a generally flat surface. Further, the cross-section may be uniform along the length of a projection 30a, 30b, as shown in FIG. 3. Alternatively, the cross-section may vary along the length of the projection. For example, the cross-section may decrease, e.g., the width of the projection may decrease, toward the tip of the projection, especially where the projection extends deep into the pleat. For many embodiments, the width of each projection may determine the distance that the legs are spaced apart. Consequently, the width may be selected in accordance with the desired pleat spacing. For most embodiments, the widths of the projections of the stabilizing arrangement may all be similar to maintain a more uniform spacing between the pleat legs for all of the pleats.

In addition to the projections, the stabilizing arrangement may also include a head structure which limits the distance that the projection extends into a pleat. The head structure may be connected to the projection and may be larger than the opening in the support, thereby limiting the distance that the projection extends through the opening into a pleat. The head structure may be configured in any of numerous ways. In the stabilizer 31 shown in FIG. 3, the head structure 32 comprises a bridging member 33 that extends between the ends of the two projections 30a, 30b generally perpendicular to each projection 30a, 30b. The bridging member 33 overlaps the section of the external support 12 between the two openings 25 into which the projections 30a, 30b extend. The stabilizer 31 thus has a generally U-shaped configuration. As another example, the head structure may comprise an elongate portion that extends generally perpendicular to the projection and overlaps a section of the support next to the opening in the support. The stabilizer may then have a generally L-shaped or T-shaped configuration. As another example, the head structure may comprise a circular or spherical portion at one end of the projection that is larger than the opening in the support and overlaps a portion of the support next to the opening.

The stabilizing arrangement 16 may also include an interlocking mechanism which mechanically connects the stabilizing arrangement to the support. The stabilizing arrangement may then be resistant to inadvertent removal, for example, when the fluid treatment arrangement is dropped or shaken or when fluid flows outwardly through the fluid treatment pack. For many embodiments, the interlocking mechanism may be one which is capable of being disconnected and perhaps reconnected and reused. For example, as shown in FIG. 3, the stabilizer 31 may include an interlocking mechanism in the form of a snap lock mechanism 34 that is dimensioned to snap around the section of the external support 12 between the two openings 25 through which the projections 30a, 30b extend. The snap lock mechanism 34 may include opposing grooves 35, 36 in the projections 30a, 30b. The section of the external support 12 between the openings 25 fits into the grooves 35, 36 with the bridging member 33 overlapping the support 12 and the projections 30a, 30b snapped back under the support 12. The snap lock mechanism 34 thus mechanically connects the stabilizer 31 to the external support 12, but it also allows the stabilizer 31 to be easily removed from the external support 12, e.g., by simply pulling the stabilizer 31 away from the support 12, and perhaps reused.

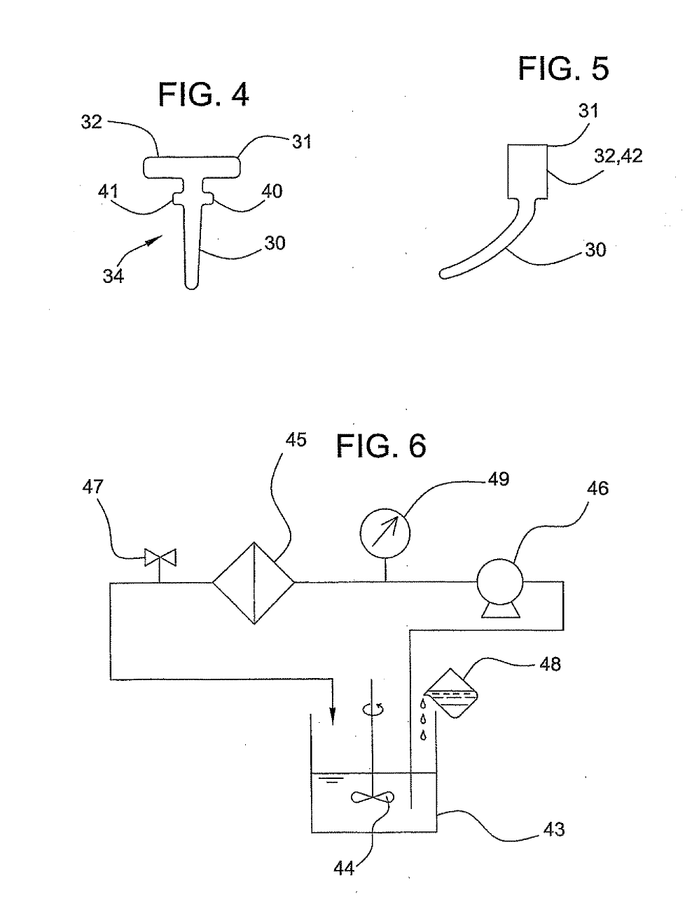

The snap lock mechanism may be configured in many other ways. For example, as shown in FIG. 4, the stabilizer 31 may have a generally T-shaped configuration including a head structure 32 and only a single projection 30. The stabilizer 31 also includes a snap lock mechanism 34 which comprises a pair of ears 40, 41 that may be deformable, e.g., bendable or compressible. As the stabilizer 31 is inserted through an opening in the support, the ears 40, 41 deform and move through the opening and then snap back into position under the support with the head structure 32 overlying the support. This mechanically connects the stabilizer 31 to the support but allows the stabilizer 31 to be easily removed, e.g., by pulling the stabilizer 31 back through the opening 25, and perhaps reused.

The interlocking mechanism may be implemented in many ways other than as a snap-lock mechanism. For example, the interlocking mechanism may be in the form of a friction or interference fit mechanism. The friction or interference fit mechanism may be variously configured. For example, the friction/interference fit mechanism and the head structure may be the same component. As shown in FIG. 5, a stabilizer 31 may include an angled projection 30 joined at one end to a head structure 32/friction or interference fit mechanism 42. The head structure 32/friction or interference fit mechanism 42 may be larger than the opening in the support but may be slightly compressible. The head structure 32/friction or interference fit mechanism 42 may be inserted partially through an opening in the support and tightly fit within the opening, mechanically connecting the stabilizer 31 to the support 12.

The stabilizing arrangement may be fashioned from a variety of materials, including metallic, elastomeric, or polymeric materials. For example, for embodiments used to treat an aggressive fluid, such as an acid, a base, or a fluid containing one or more volatile solvents, the stabilizing arrangement may be fashioned from a fluoroploymer such as PTFE. For less aggressive fluids and fluids at lower temperatures, the stabilizing arrangement may be fashioned, for example, from polypropylene or polyethylene, such as a high density polyethylene. For many embodiments, the stabilizing arrangement may be formed as a unitary piece from a single material, e.g., a single polymeric material. Many polymeric materials may be sufficiently elastic to form a reliable snap fit or friction/interference fit mechanism while also being sufficiently resistant to compression to maintain the pleat legs spaced apart.

Fluid treatment arrangements may be made in a variety of ways. For many embodiments, the fluid treatment arrangement may first be manufactured as a fluid treatment element without a stabilizing arrangement. The stabilizing arrangement may then be mounted to the fluid treatment element at any convenient time by simply inserting the projections of the stabilizing arrangement through the openings in the support and into the open ends of the pleats. For example, the stabilizing arrangement may be mounted to the support and the fluid treatment pack at the manufacturing site, at the customer's site, or anywhere in between, e.g., at a warehouse, thus allowing greater flexibility in the process for making the fluid treatment arrangement.

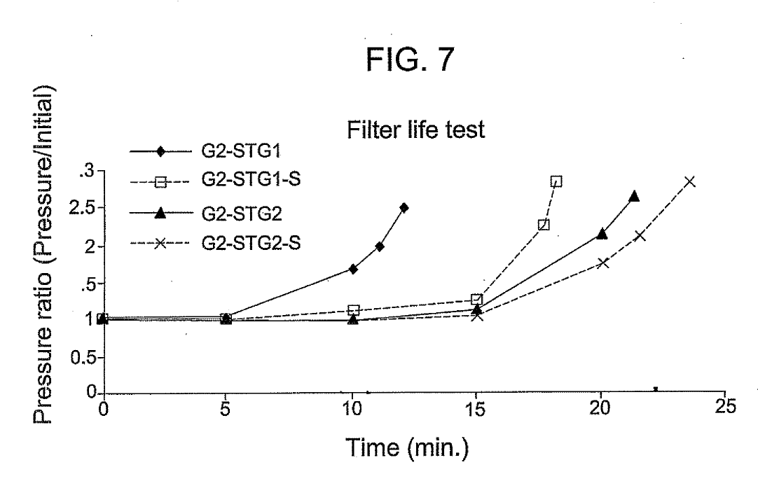

In use, fluid treatment arrangements including stabilizing arrangements can perform better than similar fluid treatment elements without stabilizing arrangements. For example, a filter cartridge designated G2-STG1-S and including a stabilizing arrangement is tested against a similar filter cartridge designated G2-STG1 without a stabilizing arrangement, and a filter cartridge designated G2-STG2-S and including a stabilizing arrangement is tested against a similar filter cartridge designated G2-STG1 without a stabilizing arrangement. The test system is shown in FIG. 6. A test liquid comprising 60% isopropyl alcohol (IPA) with cellulosic fibers and a simulated resist that forms gels is stirred in a tank 43 by a stirrer 44 and is circulated through each of the four filter cartridges 45 successively by a pump 46. The test system may further include valve 47, simulated resist source 48, and pressure gauge 49. As shown in FIG. 7, the filter cartridges with the stabilizer arrangements can perform better than the filter cartridges without stabilizer arrangements. For example, the pressure ratio can increase more slowly in the filter cartridges with the stabilizing arrangements than in the filter cartridges without the stabilizing arrangements.

Fluid treatment arrangements and methods for stabilizing the pleats of fluid treatment arrangements which embody one or more aspects of the invention have been previously described and/or shown in the Figures. However, the invention is not limited to these embodiments. Additional embodiments of the invention may be made by eliminating one or more features from an embodiment, by combining one or more features of one embodiment with one or more features of another embodiment, by modifying one or more features of an embodiment, and/or by implementing entirely different embodiments.

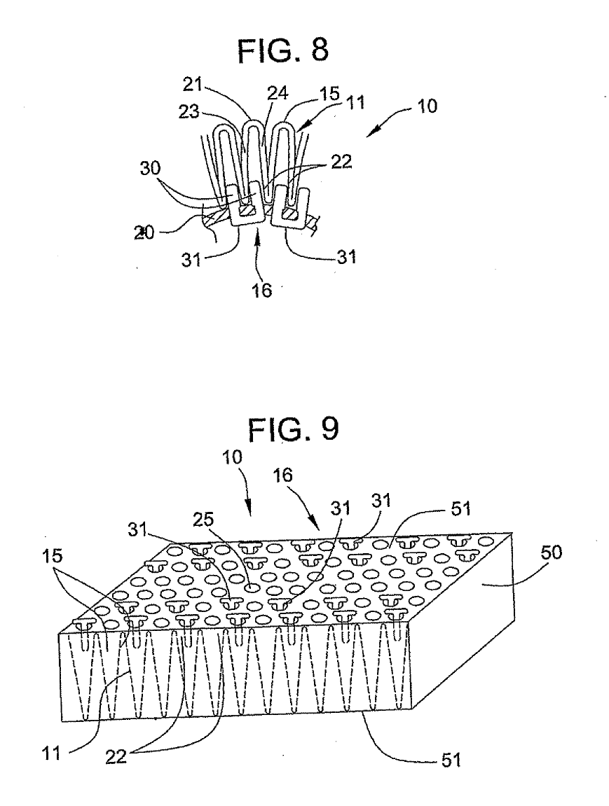

For example, a stabilizing arrangement may be connected between an internal support and a fluid treatment pack. In one embodiment of a fluid treatment arrangement 10, individual stabilizers 31 of a stabilizing arrangement 16 may be mounted between a core 20 having perforations 25 and the inner open ends 22 of the pleats 15 of a fluid treatment pack 11, as shown in FIG. 8. The stabilizers 31 shown in FIG. 8 may be similar to the stabilizers shown in previous embodiments but may have straight, generally thinner projections 30 due to the closer spacing of the pleats 15 along the inner diameter of the fluid treatment pack 11. The embodiment shown in FIG. 8 may be useful when fluid flows inside-out through the fluid treatment arrangement 10.

As another example, a fluid treatment arrangement 10 embodying one or more aspects of the invention may include a pleated fluid treatment pack 11 having the configuration of a generally flat box, as shown in FIG. 9. A frame 50 may be sealed to the edges of the pleated fluid treatment pack 11 and a generally flat support 51 may be positioned along the top and/or the bottom of the pack 11. The support 51 may have a plurality of openings 25, and a stabilizer arrangement 16 may couple the support 51 to the pleats 15 of the fluid treatment pack 11. For example, any of the previously described stabilizers 31 may be inserted through the openings 25 in the support 51 and into the open ends 22 of the pleats 15 facing the support 51, coupling the support 51 to the pleats 15.

The present invention is thus not restricted to the particular embodiments which are described and illustrated but includes all embodiments and modifications that may fall within the scope of the claims.

1. A fluid treatment arrangement comprising:
a fluid treatment pack having first and second opposite sides and a plurality of pleats, each pleat including an open end, a folded end, and a pair of legs extending between the folded end and the open end;
a support positioned adjacent to the fluid treatment pack facing one side and having a plurality of openings; and
a stabilizing arrangement coupled between the support and some or all of the pleats, the stabilizing arrangement including a plurality of projections, each projection extending through an opening in the support and into an open end of a pleat.

2. The fluid treatment arrangement of claim 1 wherein the fluid treatment pack has a hollow generally cylindrical configuration and includes an inner side and an outer side.

3. The fluid treatment arrangement of claim 2 wherein the support comprises a perforated core positioned around the inner side of the fluid treatment pack.

4. The fluid treatment arrangement of claim 3 wherein the stabilizing arrangement comprises a plurality of individual stabilizers, each stabilizer including at least one of the projections, the projection extending through a perforation in the core.

5. The fluid treatment arrangement of claim 4 wherein each stabilizer further includes an interlock mechanism which connects the stabilizer to the core.

6. The fluid treatment arrangement of claim 2 wherein the support comprises a surround positioned around the outer side of the fluid treatment pack.

7. The fluid treatment arrangement of claim 6 wherein the stabilizing arrangement comprises a plurality of individual stabilizers, each stabilizer including at least one of the projections, the projection extending through an opening in the surround.

8. The fluid treatment arrangement of claim 7 wherein each stabilizer further includes a head structure which limits the distance that the stabilizer extends into the open end of the pleat.

9. The fluid treatment arrangement of claim 7 wherein each stabilizer further includes an interlock mechanism which connects the stabilizer to the surround.

10. The fluid treatment arrangement of claim 7 wherein the surround comprises a rigid cage and wherein each stabilizer further includes a head structure which limits the distance that the stabilizer extends into the open end of the pleat and an interlock mechanism which connects the stabilizer to the cage.

11. The fluid treatment arrangement of claim 1 wherein the stabilizing arrangement comprises a plurality of individual stabilizers, each stabilizer including at least one of the projections.

12. The fluid treatment arrangement of claim 11 wherein the stabilizer further includes a head structure which limits the distance that the stabilizer extends into the open end of the pleat.

13. The fluid treatment arrangement of claim 12 wherein the stabilizer further includes an interlock mechanism which connects the stabilizer to the support.

14. The fluid treatment arrangement of claim 11 wherein the stabilizer further includes an interlock mechanism which connects the stabilizer to the support.

15. The fluid treatment arrangement of claim 11 wherein the stabilizer further includes a head structure which limits the distance that the stabilizer extends into the open end of the pleat and an interlock mechanism which connects the stabilizer to the support.

16. A method of stabilizing the legs of a pleats of a fluid treatment pack, the method comprising:
coupling a stabilizing arrangement between some or all of the pleats of the fluid treatment pack and a support facing the pleats, including inserting a projection of the stabilizing arrangement through an opening in the support and into an open end of a pleat.

17. The method of claim 16 wherein coupling the stabilizing arrangement between the pleats and the support includes axially sliding the projection along the open end of the pleat between the legs of the pleats.

18. The method of claim 16 further comprising connecting the stabilizing arrangement to the support.

19. The method of claim 18 wherein connecting the stabilizing arrangement includes mechanically interlocking the stabilizing arrangement to the support, by a snap fit 20. The method of claim 19 wherein connecting the stabilizing arrangement includes mechanically interlocking the stabilizing arrangement to the support by friction/interference fit.
